(19) United States
(12) Patent Application Publication
(10) Pub. No.: US 2002/0144583 A1
(43) Pub. Date: Oct. 10, 2002

(54) Guide arrangement for machine tools

(75) Inventor: Wiestaw Kramski, Birkenfeld (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: KRAMSKI GmbH, Pforzheim (DE)

(21) Appl. No.: 10/115,659

(22) Filed: Apr. 4, 2002

(30) Foreign Application Priority Data
Apr. 5, 2001 (DE) 101 16 917.5

(51) Int. Cl. B26D 5/08; B23Q 1/01

(52) U.S. Cl. 83/613; 83/821

(57) ABSTRACT

A guide for machine tools and the like is proposed that includes a guide column and a parallel installed tenon joint, wherein the tenon joint itself is formed from parts of the guide column and/or a guide sleeve, and the parts of the guide column and/or guide sleeve that form the tenon joint are located axially offset from or coaxial to the bearing of the guide column in the guide sleeve.

### BACKGROUND

This invention pertains to a guide arrangement for machine tools and the like, in particular for stamping tools, including at least one guide column that moves axially within a guide sleeve, extending between a machine tool part that at least indirectly holds the tool, and a workpiece machine part that at least indirectly holds the work piece. This column, together with the guide sleeve, guides the axially-directed opposite relative motion of machine tool part and workpiece machine part, with the guide column being fastened to one of the two machine parts and the guide sleeve being associated with the other of the two machine parts. A tenon joint extending in the guide column's axial direction is installed parallel to the bearing of the guide column in the guide sleeve, and the tenon joint locks the two machine parts in their radial positions in a nearly play free manner at the end of the relative motion discussed at least at the time point when the workpiece is impinged by the tool.

Guides consisting of guide columns are used in a wide variety of areas in order to make relatively short stroke motions with high guide precision. Bearings used are in general roller bearings, which influences the precision of the work done on the workpiece depending on the bearing play. In particular, for high-precision stamping tools, which are a non-exclusive example of the topic of discussion here, the bearing play is often too high to meet the very high requirements in dimensional accuracy. For this reason, in addition to the guides, a number of tenon joints are distributed about the stamping tool that guide the two machine parts in a nearly play free manner at the time when the workpiece is impinged by the tool, thus locking them in their radial direction. This allows one to be sure that the tool impinges the workpiece exactly in the position provided to within a few thousandths of a millimeter so that the workpieces can be manufactured without deviation in multiple sequential work steps by subsequent tools.

As advantageous as the tenon joints are to the results of the work, they make the design of the tool equally complicated, because in addition to the larger number of guides and guide columns of a tool, numerous tenon joints must now be provided outside the working area impinging the workpiece and outside any ejector plates, wiper plates, dies and the like so as to ensure an exactly parallel guiding of the tool. This often leads in practice to space problems and very limited configurations. Therefore, the object of this invention is to provide a guide with which to attain high guide precision and that circumvents the space problems described, and moreover that is also more reasonable and simpler to manufacture.

### SUMMARY

This objective is met according to the invention in that the tenon joint is formed from parts of the guide column and/or sleeve itself and that the parts of the guide column and/or sleeve that form the tenon joint are located axially alongside to or coaxial with the bearing of the guide column in the guide sleeve.

This results in the advantage that the bearing and the tenon joint are located in one and the same guide column aligned with one another. In this way, tool areas that are being used already anyway are utilized to also be able to provide the additional tenon joint. Since, due to the high precision requirements, the bearing surfaces as well as the tenon joint surfaces must be made of hardened metal, a more reasonable and simple form of tool manufacture can be accomplished by the same parts being used both for the bearing as well as for the tenon joint, whereas before this, twice as many hardened metal areas were needed.

With the tenon joints forming sliding bearings that are practically play free and with the tenon joint surfaces cooperating very precisely in an opposing fashion with the guide column bearing by means of the mated arrangement, the tenon joint surfaces are prevented from going out of line, which has been an obstacle up till now in the state of the technology with the increased use of slide bearings for guide columns. This is because as optimal as the guide precision of slide bearings may be, slide bearings are less applicable in practice since they go out of line too easily due to their exact dimensional accuracies when they are installed and can thus only be used with a very large amount of effort.

Thus, the bearing of the guide column provides a coarse guide for the majority of the relative motion between machine tool parts and workpiece machine part, for example for the 10-100 mm in width when opening the tool after the stamping process, whereas the tenon joint that aligns with the bearing, especially at the critical time point when the workpiece is impinged by the tool acts as a fine guide along a stroke length of 2-3 mm in order to guarantee the high manufacturing precision. The aligned arrangement of the tenon joint on the guide column also leads to a simplification in that in manufacturing and assembling the tool, the position of all tenon joints in the machine tool part on the one hand do not have to be exactly fitted to their positions in the workpiece machine part on the other have in addition to all guide columns distributed over the tool being fitted to their respective guide sleeves. To the contrary, if the position of the guide columns and the guide sleeves are exactly fitted, the subsequent locating of the tenon joints aligned with the guide columns and guide sleeves is practically not a problem any longer.

In this regard, it is recommended that the guide column have a widened cross section that functions as a tenon, which forms the tenon joint together with a part of the guide sleeve functioning as a mortise. It is noted here that the tenon and mortise can each be formed in one piece together with the guide column or guide sleeve, respectively, or also separate from them. The importance is only the association of the tenon joint with guide column or guide sleeve, and the opposite coaxial or aligned arrangement.

It is useful to radially offset the mortise of the guide sleeve outward from the part of the guide sleeve that forms the bearing surface for the guide column so that the bearing for the guide column does not impinge on the mortise of the guide sleeve. This can, for example, be done by a small recess that ensures that the bearing parts do not damage the very precisely produced mortise.

Whereas, as described above, it is also possible, in principle, to use a slide bearing to guide the guide column in the guide sleeve, in this case the bearing used is an antifriction bearing for the sake of simplicity, since the necessarily high dimensional accuracy at the time point that the workpiece is impinged by the tool is provided by the tenon joint. The antifriction bearing is preferably formed by a ball bearing with a ball cage, located between the guide column and the guide sleeve, wherein the balls ride on the bearing surface of the guide column and the guide sleeve. It is also naturally possible to use other types of antifriction bearings, for example roller bearings.

The simplest design is for the widened guide column cross section that forms the tenon to be formed by an annular radially protruding collar whose outside diameter is adjusted to fit the mortise and which protrudes outward radially from the bearing surface of the guide column, at least by the thickness of the bearing, i.e. in particular of the antifriction bearing.

Regarding the guide column, all known embodiments from the state of the technology can be used without exception; however, to prevent too large of a separation between the point of force application and fastened surfaces, it is recommended to fix the guide column to the machine tool part by means of a center collar fastener in the manner shown in the following embodiment example.

As already mentioned above, this invention can also be used in any type of machine tool with short strokes, for example injection and pressure casting machines or other tools/machines that must meet high precision requirements. It is expressly stressed that this invention also extends to these and other similar areas of application whereby the features used in the claims for better readability, such as “tool” and “workpiece” must be correspondingly changed. Thus, these features correspond, for example for pressurized casting machines, to the two halves of the casting form that have to be brought to positions exactly fitting one another, guided by the guide columns and tenon joints.

A preferred embodiment is used in the area of stamping machines so that the guide column of an upper tool section that holds a stamping tool is associated with a stamping machine and fastened to it, that the guide sleeve is associated with a cutting frame of a stamping machine that holds a sheet to be stamped and that the upper tool section with its guide column makes a vertical stroke to be directed at the cutting frame containing the guide sleeve, and that the tenon joint at the end of the closing stroke takes effect at least in and in particular also shortly prior to the time point that the stamping workpiece is impinged by the stamping tool.

With regard to the axial stroke of the tenon joint, i.e. the maximum engagement depth of the tenon in the mortise, this is naturally dependent on the dimensions of the workpiece. At sheet thicknesses commonly processed in the stamping tool described, the axial tenon joints stroke is approximately 2 to 3 mm, whereas the overall stroke of the tool from the closed position with the tenon joint engaged to the open position is in the order of magnitude of between 10 and 100 mm.

With regard to the play within the tenon joint, this must be small enough that manufacturing precision, for example of the high precision stamping tool described, can be guaranteed to within approximately 0.002 and 0.030 mm. In other words, this means that the play within the tenon joint must therefore be in the order of magnitude of a few thousandths of a millimeter.

### BRIEF DESCRIPTION OF THE DRAWINGS

Other features and advantages of this invention can be found in the following description of a preferred embodiment with the help of the drawing. In the drawings:

FIG. 1 is a side view of a guide according to the invention in the open position;

FIG. 2 is a plan view of the guide in FIG. 1;

FIG. 3 is a side view of the guide in FIG. 1 in the closed position; and

FIG. 4 is a plan view of the guide in FIG. 3.

### DETAILED DESCRIPTION OF THE PREFERRED EMBODIMENTS

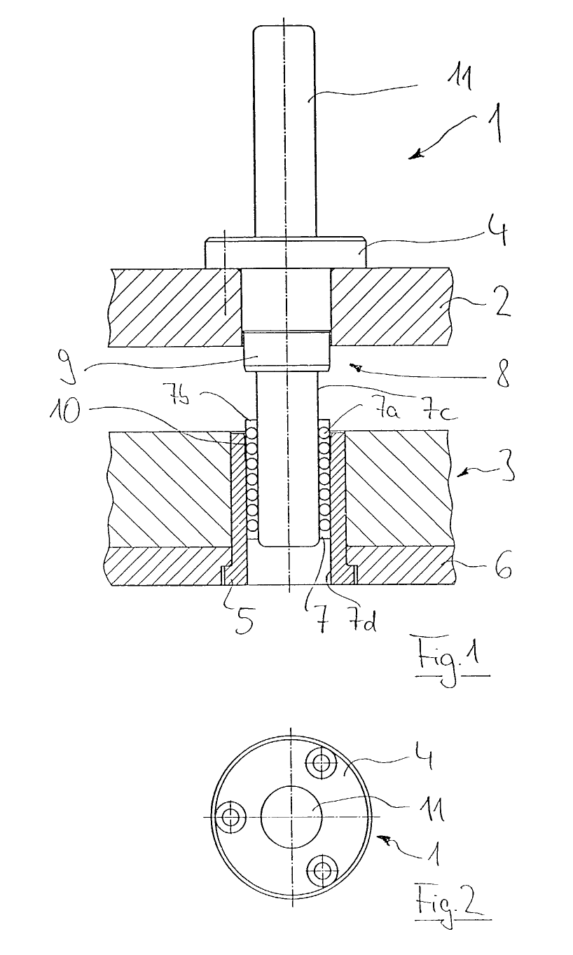

In FIG. 1, a guide 1 according to the invention is shown containing a guide column 11, which is part of a machine tool (most of which is not shown) and which extends between a machine tool part 2 that holds at least indirectly the tool and a workpiece machine part 3 that holds at least indirectly the workpiece. In the preferred embodiment of a stamping tool, the machine tool part 2 is designed in the form of an upper tool section and the workpiece machine part 3 is designed in the form of a cutting frame next to the lower pressure plate 6 attached below it.

The relative opposing motion of the machine tool part and workpiece machine part in the axial direction of the guide column is done by the guide column 11, which is bolted to the machine tool part 2 by means of a center collar 4, and a guide sleeve 5 contained in the workpiece machine part 3. The guide sleeve in turn is fastened in workpiece machine part 3 coaxial to the guide column 11 and penetrates the lower pressure plate 6.

Between the guide column and the guide sleeve is a ball bearing 7 that provides the desired axial guiding during a stroke in the order of magnitude of between 10 and 100 mm. The bearing balls 7a are held in a ball cage 7b and roll along bearing surface 7c of the guide column 11 and bearing surface 7d of the guide sleeve 5.

In order to hold the radial deviation of this axially guided stroke in an order of magnitude of between 2 and 30 thousandths of a millimeter, at least at the time point when the tool impinges the workpiece, the guide 1 has a tenon joint 8. This tenon joint includes a tenon 9 located on the guide column 11, in the form of a widening in the radial cross section, and a mortise 10 provided at the guide sleeve 5 that is also formed by a widening in the radial cross section on the bearing surface 7d in order to not be impinged and possibly damaged by the balls 7a of the ball cage 7b.

In FIG. 1, the guide is shown in the open position, wherein the guide column 11 is guided by only the ball bearing 7 in the guide sleeve 5.

In the plan view according to FIGS. 2 and 4, in each case the guide column 11 and the three screw connections of the center collar 4 to the machine tool part 2 are shown.

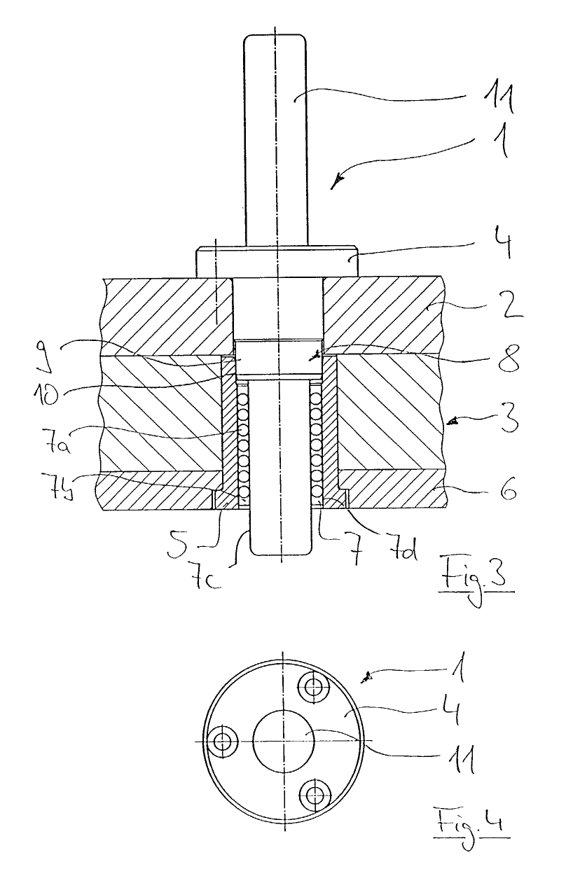

Finally, FIG. 3 shows the guide in the closed position. Here, the machine tool part 2 and the workpiece machine part 3 are run up against one another, wherein at the same time the free lower end of the guide column 11 is plunged further into the guide sleeve 5 to the point where the tenon 9 has impinged the mortise 10 along a tenon stroke length of approximately 2 to 3 mm. This 2 to 3 mm tenon stroke length must be selected to be large enough to make the entire work process, i.e. in this case the stamping process, occur at the same time that the tenon is engaged into the mortise so that the radial deviation mentioned is guaranteed to be in the order of magnitude of a few thousandths of a millimeter at least during the stamping process.

It is not hard to see that the minimal radial play of the tenon in the mortise required here results in increased friction accordingly. Therefore, it is recommended to apply a lubricant through lubrication holes in the guide column or in the tenon or in the mortise or guide sleeve. This lubricant provides a sliding guide and thus for an improvement of the frictional or sliding characteristics.

In summary, this invention offers the advantage of a system available with extreme space savings and minimal material requirements, which includes guide columns and integrated tenon joints that make work possible by machine tools, pressure casting machines and similar equipment having an axial stroke without radial deviation. To this end, the tenon joint is provided coaxial to or axially alongside the guide bearing on the guide column and takes effect only when the tenon and mortise of the respective work process, i.e. the stamping process, pressure casting process, etc, engage one another. Also, the tenon joint does not hinder the guide stroke or the other work done using the respective machine tool.

1. A guide for machine tools, comprising at least one guide column (11) that moves axially within a guide sleeve (5), extending between a machine tool part (2) that at least indirectly holds the tool and a workpiece machine part (3) that at least indirectly holds a work piece, the column, together with the guide sleeve, guides an axially-directed opposite relative motion of the machine tool part and workpiece machine part, with the guide column being fastened to one of the machine tool and workpiece machine parts and the guide sleeve being associated with the other of the two machine tool and workpiece machine parts, wherein a tenon joint (8) extending in an axial direction of the guide column is installed parallel to a bearing of the guide column in the guide sleeve, and wherein the tenon joint locks the machine tool part and the workpiece machine part in their radial positions in a nearly play free manner at an end of the relative motion at least at a time point when the workpiece is impinged by the tool,
the tenon joint (8) is formed from parts (9, 10) of at least one of the guide column (11) and the sleeve (5), and the parts of at least one of the guide column and the sleeve that form the tenon joint are located at least one of alongside and coaxial with the bearing (7) of the guide column in the guide sleeve.

2. A guide according to claim 1, wherein
the guide column (11) has a widened cross section in one area that functions as a tenon (9) of the tenon joint (8) together with a part of the guide sleeve (5) that functions as a mortise (10).

3. A guide according to at least claim 2, wherein
the mortise (10) of the guide sleeve (5) is larger in diameter than a part of the guide sleeve that forms a bearing surface (7d) for the bearing (7) for the guide column (11).

4. A guide according to claim 1, wherein
the bearing of the guide column (11) in the guide sleeve (5) is a roller bearing (7).

5. A guide according to at least claim 4, wherein
the rolling bearing (7) is a ball bearing held in a ball cage (7b), wherein balls (7a) of the roller bearing contact a bearing surface (7c) of the guide column (11) and a bearing surface (7d) of the guide sleeve (5).

6. A guide according to at least claim 2, wherein
the widened cross section forming the tenon (9) of the guide column (11) is formed by an annular, radially protruding collar.

7. A guide according to claim 1, wherein
the guide column (11) is fixed to the machine tool part (2) through a center collar fastener (4).

8. A guide according to claim 1, wherein
the guide column (11) is associated with and fastened to an upper tool section (2) of a stamping machine that holds a stamping tool.

9. A guide according to claim 1, wherein
the guide sleeve (5) is associated with and fastened to a cutting frame (3) of a stamping machine that holds a sheet to be stamped.

10. A guide according to claim 1, wherein
the guide column (11) is associated with and fastened to an upper tool section (2) of a stamping machine that holds a stamping tool, and the guide sleeve (5) is associated with and fastened to a cutting frame (3) of a stamping machine that holds a sheet to be stamped, the upper tool section (2), with the guide column (11) makes a vertical stroke directed onto the cutting frame (3) and the guide sleeve (5), and the tenon joint (9) takes effect at an end of the closing stroke at least at, and in particular just prior to, the time point when the stamping workpiece is impinged by the stamping tool.

11. A guide according to claim 1, wherein
an axial stroke of the tenon joint has an order of magnitude of 2 to 3 mm.
